(19) United States
(12) Patent Application Publication
(10) Pub. No.: US 2003/0156217 A1
(43) Pub. Date: Aug. 21, 2003

(54) Information input apparatus

(75) Inventor: Satoshi Ejima, Setagaya-ku (JP)

Correspondence Address: OLIFF & BERRIDGE, PLC, P.O. BOX 19928, ALEXANDRIA, VA, 22320, US

(73) Assignee: Nikon Corporation, Tokyo (JP)

(21) Appl. No.: 10/095,695

(22) Filed: Mar. 13, 2002

Related U.S. Application Data
(63) Continuation of application No. 09/883,961, filed on Jun. 20, 2001, now abandoned.
Application No. 09/883,961 is a continuation of application No. 08/813,652, filed on Mar. 7, 1997, now abandoned.

(30) Foreign Application Priority Data
Apr. 3, 1996 (JP) 8-081164
May 7, 1996 (JP) 8-112378

(51) Int. Cl. H04N 5/225

(52) U.S. Cl. 348/373; 348/376

(57) ABSTRACT

An information input apparatus is shown having an integral touch tablet positioned on a surface of a digital camera relative to a photographic lens, a microphone and operating switches such that the camera can easily be operated to take pictures and record sounds while two-dimensional positional information is input via the touch tablet. The camera can be inserted into a shirt pocket, with the photographic [symbol] finder, and light-emitting component being positioned such that they protrude from the pocket, thus allowing photography of objects while the apparatus is inserted into a shirt pocket. The view finder is positioned approximately half way between the left and right sides of the camera, and the total width of the camera is small enough such that an object can be observed with both eyes when looking through the finder with either eye.

### BACKGROUND OF THE INVENTION

1. Field of Invention

The present invention relates to an information input apparatus. More particularly, it relates to a digital camera, for example, that records the images of objects by converting them into digital data.

2. Description of Related Art

In recent years, electronic cameras, which photograph the images of objects using a CCD, convert them into digital data, and record them on memory cards, have come to be used in place of cameras that use film. The images photographed using these electronic cameras can be reproduced on the spot and displayed on LCD screens without undergoing development and printing as with the conventional cameras.

Also, because they record the photographed images as digital data, they have good compatibility with personal computers, and they have become usable as input devices for computers. For example, they may be used as tools for inputting image data when creating Internet home pages.

However, for the conventional electronic camera, there has been no fundamental change in the operating method, whereby, in the same manner as the case of a camera using film, it is held with both hands or one hand, and the shutter is pressed while orienting the lens toward an object. Conventional cameras are limited in operability and functionality for many business uses.

FIG. 20 and FIG. 21 are perspective views of one example of the composition of a portable information input apparatus, wherein the electronic camera and an electronic notebook have been made as an integral unit. In this information input apparatus, a touch tablet 109 having a pressure-sensitive surface is positioned over the surface of a display device, such as, for example, a liquid crystal panel. The user can input information by pressing the touch tablet 109 with the pen point of a pen-type pointing device 110, shown in FIG. 22.

When employing this information input apparatus to photograph a subject, the user looks through the finder 102 to confirm the shooting range of the subject. Then, when the release switch 103, provided on the top surface of this information input apparatus, is operated, light from the subject is collected by the photographic lens 104, and is photoelectrically converted into image signals by a photoelectric conversion unit (for example, such as a CCD). Moreover, at this time, the subject may be illuminated by emitting light from the light-emitting component 105.

When the desired information is input to the touch tablet 109 of this information input apparatus, as shown in FIGS. 22 and 23, for example, the user holds the information input apparatus in his left hand 120, operates the pen-type pointing device 110 with his right hand, and inputs information by contacting the touch tablet 109 with the pen point. In order to suppress hand trembling during image input, the left hand 120, as shown in FIG. 22, must securely hold the surface opposite to the surface on which the touch tablet 109 is formed.

In this kind of information input apparatus, when a shutter opportunity occurs while inputting information to the touch tablet 109, a problem occurs. Namely, in the state shown in FIGS. 22 and 23, the right hand of the user is occupied with the pen-type pointing device 110, and the left hand 120 of the user is occupied with holding the information input apparatus. Accordingly, even though a shutter opportunity has occurred, the user cannot easily operate the release switch 103 provided on the top surface of the information input apparatus, and the shutter opportunity is lost.

Furthermore, the photographic lens 104 and the light emitting component 105 are covered by the left hand 120 that is holding the information input apparatus, and it becomes troublesome to reliably photograph the desired subject.

### SUMMARY OF THE INVENTION

The present invention was made in consideration of such circumstances, and it is made to be able to photograph more efficiently the images of objects.

The information input apparatus of the present invention comprises an imaging means (e.g., photographic lens 3 of FIG. 1, finder 2 and CCD 20 of FIG. 3) that receives the images of the specified objects; a memory means (e.g., memory card 24 of FIG. 3) that stores the images received by the imaging means, and a rectangular box-like housing (e.g., case 100 of FIG. 1) that houses these components. The height of the housing is the maximum outer dimension, with the width forming an intermediate dimension and the depth forming the minimum dimension. An upper portion of the front surface of the housing projects forward from the rest of the front surface across the entire width of the housing to form an upper projection. The imaging means is positioned in the upper projection and is oriented parallel to the width of the camera. The recording means or memory means is placed in the housing at a position vertically below the imaging means. The length of the outer perimeter of the housing means at a portion of the housing below the upper projection is restricted to no larger than a first base value, and the vertical distance between the bottom surface of the housing and the imaging means is restricted to no less than a second base value, with the first and second base values being determined by the dimensions of a standard shirt pocket.

The apparatus further comprises a power supply means (e.g., batteries 21 of FIG. 3) that supplies power to the imaging means and the memory means.

The power supply means is placed in the housing at a position vertically below the imaging means.

The apparatus further comprises an illumination means (e.g., light-emitting component (strobe) 4 of FIG. 1) that projects illumination on the objects.

The apparatus further comprises a display means (e.g., LCD 6 of FIG. 2) that displays the images imaged by the imaging means, and the images stored by the memory means. A touch tablet is provided over at least a portion of the display means and provides an input device for receiving two-dimensional positional data.

Also, the photographic lens 3 can be constructed to telescope in the direction of the depth of the housing, such that it can extend from and retract into the upper projection of the housing.

The apparatus further comprises a voice input means (e.g., microphone 8 of FIG. 1) that inputs the specified voice information, whereby the memory means stores the voice information input by the voice input means.

Furthermore, the memory means can record the images and the voice information by annexing identifying data to the recorded information. The identifying data can include the time and date of receipt of the information.

### BRIEF DESCRIPTION OF THE DRAWINGS

FIG. 1 is a front perspective view showing one preferred embodiment of the electronic camera according to the present invention;

FIG. 2 is a rear perspective view of the electronic camera;

FIG. 3 is a perspective view showing one example of the internal structure of the electronic camera;

FIG. 4 is a schematic drawing showing one example of the internal electrical structure of the electronic camera;

FIG. 5 is an elevational view of a display screen displayed on the LCD of the electronic camera;

FIG. 6 is a sketch showing the pixel thinning out process that takes place when in the L mode;

FIG. 7 is a sketch showing the pixel thinning out process that takes place when in the H mode;

FIG. 8 is a front perspective view showing the electronic camera inserted into a shirt pocket;

FIG. 9 is a front perspective view showing the outer dimensions of the camera;

FIG. 10 is a front elevation view showing the vertical and horizontal dimensions of a typical shirt pocket;

FIG. 11 is a front elevation view showing a user looking through finder 2 of the electronic camera 1 with the right eye;

FIG. 12 is a front elevation view showing a user looking through finder 2 of the electronic camera with the left eye;

FIG. 13 is a front perspective view showing an embodiment of the electronic camera wherein the photographic lens telescopes forward;

FIG. 14 is a front perspective view showing another embodiment of the electronic camera wherein the photographic lens telescopes forward;

FIG. 15 is a sectional view showing an approximation of the external perimeter of a contoured portion of the camera below the upper projection;

FIG. 16 is a front perspective view showing the information input apparatus 1 being held in the left hand;

FIG. 17 is a rear perspective view showing the information input apparatus 1 being held in the left hand;

FIG. 18 is a front perspective view of an alternative embodiment of the information input apparatus being held in the left hand;

FIG. 19 is a rear perspective view of the alternative embodiment of FIG. 18 being held in the left hand;

FIG. 20 is a rear perspective view of an information input apparatus with an integral electronic notebook;

FIG. 21 is a front perspective view of the apparatus of FIG. 20;

FIG. 22 is a rear perspective view of the apparatus of FIGS. 20 and 21 being held in the left hand; and

FIG. 23 is a front perspective view of the apparatus of FIG. 22 being held in the left hand.

### DETAILED DESCRIPTION OF PREFERRED EMBODIMENTS

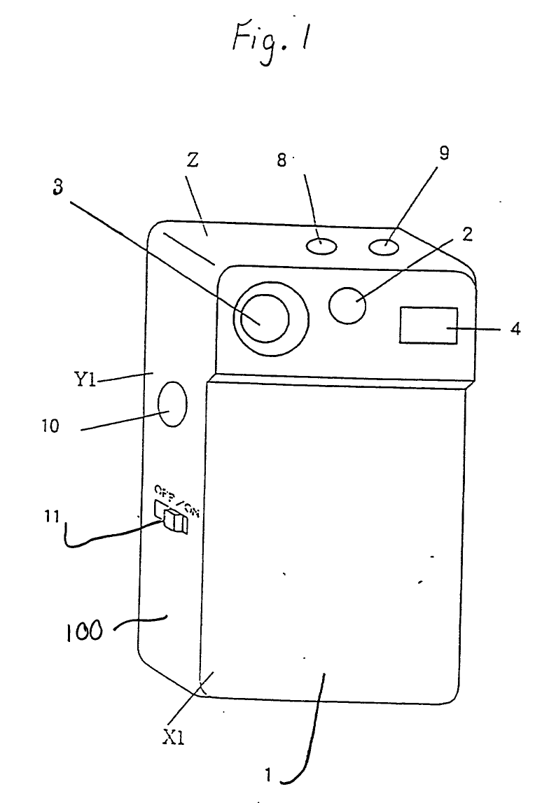

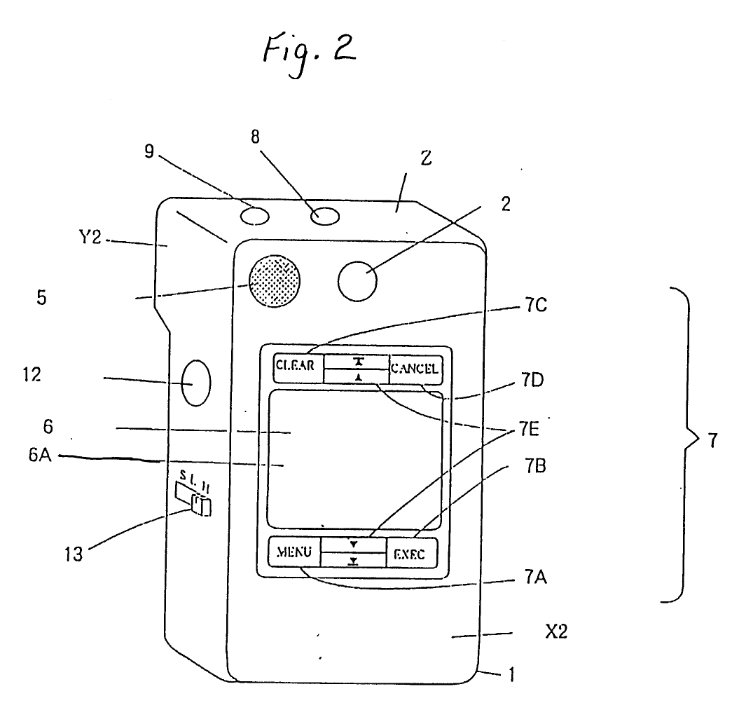

FIGS. 1 and 2 are perspective drawings showing the structure of one embodiment of the electronic camera 1 or information input apparatus according to the present invention. When photographing an object, the side of camera 1 facing the object is X1, and the side facing the user is X2. On the upper end of the side X1 are provided a finder 2 used to confirm the photographic range of the object, a photographic lens 3 that takes in the light image of the object, and a light-emitting component 4 (strobe) that emits light illuminating the object.

On the upper end of the side X2, opposite the side X1 (the position opposite the upper projection including the finder 2, lens 3, and light-emitting component 4 of the side X1), are provided the rear end of finder 2 and a speaker 5. The speaker 5 outputs sounds corresponding to the voice data recorded on a memory card 24 installed in the electronic camera 1. A display LCD 6 and operating keys 7A-7E are formed on side X2 vertically below the finder 2, photographic lens 3, light-emitting component 4, and speaker 5. A touch tablet 6A is formed on the surface of the LCD 6, and two-dimensional positional information indicated by contact with a pen-type pointer 6B (FIG. 4) are input as information to be recorded on memory card 24.

The touch tablet 6A is composed of a transparent resin, such as glass resin, and the user can monitor the images displayed to the LCD 6 formed inside the touch tablet 6A.

The operating keys 7A-7E consist of multiple keys corresponding to the various functions described below, are operated by the pen-type pointing device 6B, and are used when reproducing such recorded data as image data, sound data, or text data recorded on memory card 24, as explained later. For example, the menu key 7A is operated when displaying menu screens on the LCD 6. The execute (run) key 7B is operated when reproducing recorded data selected by the user.

Also, the clear key 7C is operated when deleting recorded data. The cancel key 7D is operated when interrupting reproduction processing of the recorded data. The scroll key 7E is operated when scrolling the screens up and down when lists of the recorded data are displayed on the LCD 6.

A microphone 8 that collects voice information and an earphone jack 9 for connection to an earphone, are positioned on the side Z on top of electronic camera 1.

On the left side (side Y1) are provided a release switch 10 operated when photographing objects and a power switch 11 that switches the power supply on and off. The release switch 10 and power switch 11 are placed vertically below the finder 2, photographic lens 3, and light-emitting component 4 provided on the upper end of side X1.

Provided on the side Y2 (right side), opposite side Y1, are a voice recording switch 12 operated when recording voice information and a continuous mode switch 13 (first modification means) operated when switching the continuous mode during photography. The voice recording switch and continuous mode switch 13 are placed vertically below the finder 2, photographic lens 2, and light-emitting component 4 provided on the upper end of side X1, in the same manner as the release switch 10 and power switch 11 mentioned above. Also, the voice recording switch 12 is formed at nearly the same height as the release switch 10 on side Y1, and it is formed such that there is no feeling of incongruity when held by either the left or right hand.

By making positively different the heights of the release switch 10 and the voice recording switch 12, it can be made such that the switch provided on one side of the camera is not pressed accidentally when activating the switch on the opposite side and applying pressure to the one side to hold the camera steady.

The continuous mode switch 13 mentioned above is used in the case of setting whether to photograph the object in only one frame or to photograph it in a fixed multiple of frames when the user photographs the object by pressing the release switch 10. For example, when the indicator of the continuous mode switch 13 is switched to the position printed with “S” (that is, switched to S mode), only one frame of photography is performed when the release switch 10 is pressed.

Also, when the indicator of the continuous mode switch 13 is switched to the position printed with “L” (that is, switched to L mode), photography at a rate of 8 frames per second is performed during the time the release switch 10 is pressed. That is, low-speed continuous mode photography is performed.

Furthermore, when the indicator of the continuous mode switch 13 is switched to the position printed with “H” (that is, switched to H mode), photography at a rate of 30 frames per second is performed during the time the release switch 10 is pressed. That is, high-speed continuous mode photography is performed.

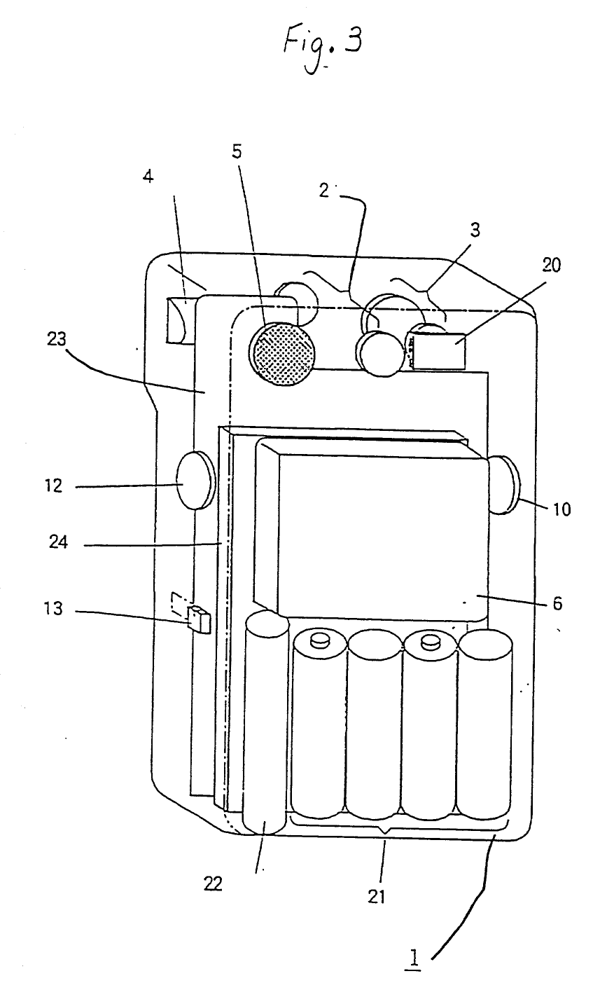

Next, the internal structure of the electronic camera 1 is explained. FIG. 3 is a perspective drawing showing examples of the internal structure of the electronic camera shown in FIGS. 1 and 2. A CCD 20 is provided at the rear end (on side X2) of the photographic lens 3, and it photoelectrically converts into electrical signals the light images of the objects formed via the photographic lens 3.

Vertically below the LCD 6 are arranged, for example, four cylindrical batteries (size AA dry cells) 21, and the electric power accumulated in these batteries 21 is supplied to each component. Also, a condenser 22 that accumulates the load required when the light-emitting component 4 emits light is placed along side the batteries 21.

On a circuit board 23 are formed various control circuits that control each component of the electronic camera 1. Also, between the circuit board 23, and the LCD 6 and batteries 21 is provided an installable/removable memory card (recording media) 24, and all types of information input into the electronic camera 1 are recorded variously in predefined areas of the memory card 24.

In the present preferred embodiment, the memory card 24 is installable and removable, but memory may be provided on the circuit board 23, and various types of information can be recorded in that memory. Also, the various types of information recorded on the memory card (or memory) also may be output to a personal computer via an interface, not shown.

Next, the internal electrical structure of the electronic camera 1 of the present preferred embodiment is explained, referring to the block drawing shown in FIG. 4. A CCD 20 having multiple pixels photo-electrically converts into image signals (electrical signals) the light images formed on each pixel. A CCD drive circuit (VDRV) 39 is controlled by a digital signal processor (henceforth, DSP) 33, described later, so as to drive the CCD 20.

A correlation duplex sampling circuit (henceforth, CDS) 31 samples at a specified timing the image signals photoelectrically converted by the CCD 20. An AGC (automatic gain control circuit) 40 controls the gain of the signals sampled by the CDS 31. An analog/digital conversion circuit (henceforth, A/D conversion circuit) 32 digitizes the image signals sampled by the CDS 31 and provides them to the digital signal processor 33.

The DSP 33 temporarily supplies the digitized image data and stores it in the buffer memory 37. A compression/decompression memory control circuit (comp/dcomp/MC) 38 reads the image data stored in the buffer memory 37, and after compressing it, for example, with the JPEG (Joint Photographic Experts Group) method, explained later, provides it via a data bus 42 to the memory card 24, and records it in the specified area (image recording area).

Also, the CPU 34 contains a clock circuit, not shown, and it records the date and time photographed as header information of the image data in the image recording area of the memory card 24. That is, to the image data recorded in the image recording area of the memory card 24 is annexed the photographic date and time data.

The microphone (mike) 8 inputs voice information and provides the voice signals corresponding to the voice information to a voice IC 36. After the voice IC 36 has converted the provided voice signals into digital voice data and compressed them, it provides them to the memory card 24, and records them in the specified area (voice recording area). Also, at this time, in the voice recording area of the memory card 24 is recorded the voice recording date and time data as the header information of the voice data.

Also, the strobe (light-emitting component) 4 is controlled by the CPU 34 so as to emit light at the specified timing and project light onto the objects.

When a specified position of the touch tablet 6A is pressed by the user with the pen-type pointing device 6B, the CPU 34 acquires the XY coordinates corresponding to the pressed position on the touch tablet 6A, and stores that coordinate data (constituting the line-drawing information discussed later) in the specified memory, not shown. Also, the CPU 34 provides to the memory card 24 the line-drawing information stored in memory, along with the header information, such as the date and time the line-drawing information was input, and records them in the line-drawing information recording area.

To the CPU 34 are connected the buffer memory 37 and the LCD 6 via a CPU control bus 41, so that it can display on the LCD 6 the images corresponding to the image data recorded in the buffer memory 37. However, the image data having undergone compression processing is input into a compression/decompression memory control circuit 38, and after being decompressed, is provided to the buffer memory 37 via the data bus 42.

Also, to the voice IC 36 is connected the speaker 5 such that the voice data read out from the memory card 24, after being decompressed by the voice IC 36 and converted into analog voice signals, is then output from the speaker 5.

Also, the operating switches 35 correspond to the release switch 10, power switch 11, voice recording switch 12, and continuous mode switch 13 in FIGS. 1-3, and when each switch is operated, the corresponding signal is provided to the CPU 34. Also, the CPU 34 executes the corresponding specified processing when each switch is operated.

Next, operation of the invention is explained. First, input/output processing of voice information in the preferred embodiment mentioned above is explained. When the power source is supplied to the information input apparatus 1 by switching the power switch 11, shown in FIG. 1, to the side printed “ON,” and the voice recording switch 12 provided on side Y2 is pressed, voice recording processing (process performing input of voice information and its recording) is started. That is, after the voice information input via the microphone 8 is converted into digital voice data by the voice IC 36, and has undergone compression processing, it is provided to the memory card 24 and is recorded in the voice recording area of the memory card. At this time, in the voice recording area of the memory card 24 the voice recording date and time is recorded as the header information of the compressed voice data. Such actions are executed repeatedly while the voice recording switch 12 is pressed.

The PCM (Pulse Code Modulation) method or another method may be used as the voice compression method.

Next the actions when photographing objects are explained. First, the case when the continuous mode switch 13 provided on side Y2 is switched to the S mode (the mode performing only one frame of photography) is explained. First, the power switch 11 provided on side Y1 is switched to the side printed “ON,” and the power is supplied to the electronic camera 1. When confirming the object with the finder 2, and pressing the release switch 10 provided on side Y1, photographic processing of the object is started.

The light image of the object observed with the finder 2 is collected by the photographic lens 3, and the image is formed on the CCD 20 having multiple pixels. The light image of the object formed on the CCD 20 is photoelectrically converted into image signals in each pixel, and is sampled by the CDS 31. After the image signals sampled by the CDS 31 have their gain controlled via the AGC 40, they are provided to the A/D conversion circuit 32, digitized there, and provided to the DSP 33.

The DSP 33 temporarily provides the digitized image data to the buffer memory 37 and stores it. The compression/decompression memory control circuit 38 compresses the image data read out from the buffer memory 37 according to the JPEG method, combining discrete cosine conversion, quantization, and Huffman encoding. The compression/decompression memory control circuit 38 provides the compressed image data to the memory card 24 via the data bus 42. The memory card 24 records in the image recording area the image data provided by the compression/decompression memory control circuit 38. At this time, in the image recording area the photographic date and time data is recorded as the header information of the image data mentioned above.

When the continuous mode switch 13 is switched to the S mode, only one frame of photography is performed each time the release switch 10 is pressed. Consequently, even the when the release switch 10 is pressed and continuously pressed in that manner, only one frame of photography is performed. Also, when the release switch 10 is continuously pressed only for a specified time, the photographed image data is displayed on the LCD 6.

Next, the case when the continuous mode switch 13 is switched to the L mode (the mode performing continuous shooting of 8 frames per second) is explained. When the power source is supplied to the electronic camera 1 by switching the power switch 11 to the side printed “ON,” and the release switch 10 provided on side Y1 is pressed, photographic processing of the object is started.

The light image of the object observed by the finder 2 is collected by the photographic lens 3, and is formed on the CCD 20 having multiple pixels. The light image of the object formed on the CCD 20 is photoelectrically converted into image signals in each pixel, and is sampled by the CDS 31 at a rate of 8 times per second. Also, at this time, the CDS 31 thins out the equivalence of ¾ of the pixels among the electrical image signals corresponding to all the pixels of the image in the CCD 20.

Namely, the CDS 31 divides the pixels of the CCD 20 arranged in matrix form, as shown in FIG. 6, with one region being defined as 2×2 pixels (4 pixels), and from this one region, samples the image signals of one pixel arranged in the prescribed position, and thins out the remaining three pixels.

For example, in the first round of sampling time (of (all the pixels in) one frame), the top left pixel “a” of each region is sampled, and the other pixels b, c, and d are thinned out. In the second round of sampling time (of two frames), the top right pixel “b” of each region is sampled, and the other pixels a, c, and d are thinned out. Then, in the sampling time of the third and fourth rounds, the lower left pixel “c” and the lower right pixel “d”, are sampled, respectively, and the other pixels are thinned out. In short, various (each of the) pixels are sampled in each of the four frames.

The image signals sampled by the CDS 31 (the image signals of ¼ the pixels among all the pixels in the CCD 20) are provided to the A/D conversion circuit 32, are digitized there, and output to the DSP 33.

The digitized image data is provided temporarily by the DSP 33 to the buffer memory 37 and stored. The image data stored in the buffer memory 37 is read out by the compression/decompression memory control circuit 38, and compressed according to the JPEG method. The data having undergone compression processing in the compression/decompression memory control circuit 38 is provided to the memory card 24 via the data bus 42, and stored in the image recording area. At this time, the photographic date and time data is recorded in the image recording area as the header information of the image data mentioned above.

Next, the case when the continuous mode switch 13 is switched to the H mode (the mode performing continuous shooting of 30 frames per second) is explained. When the power source is supplied to the electronic camera 1 by switching the power switch 11 to the side printed “ON,” and the release switch 10 provided on side Y1 is pressed, photographic processing of the object is started.

The light image of the object observed by the finder 2 is collected by the photographic lens 3, and is formed on the CCD 20. The light image of the object formed on the CCD 20 having multiple pixels is photoelectrically converted into image signals in each pixel, and is sampled by the CDS 31 at a rate of 30 times per second. Also, at this time, the CDS 31 thins out the equivalence of 8/9 of the pixels among the electrical image signals corresponding to all the pixels of the image in the CCD 20.

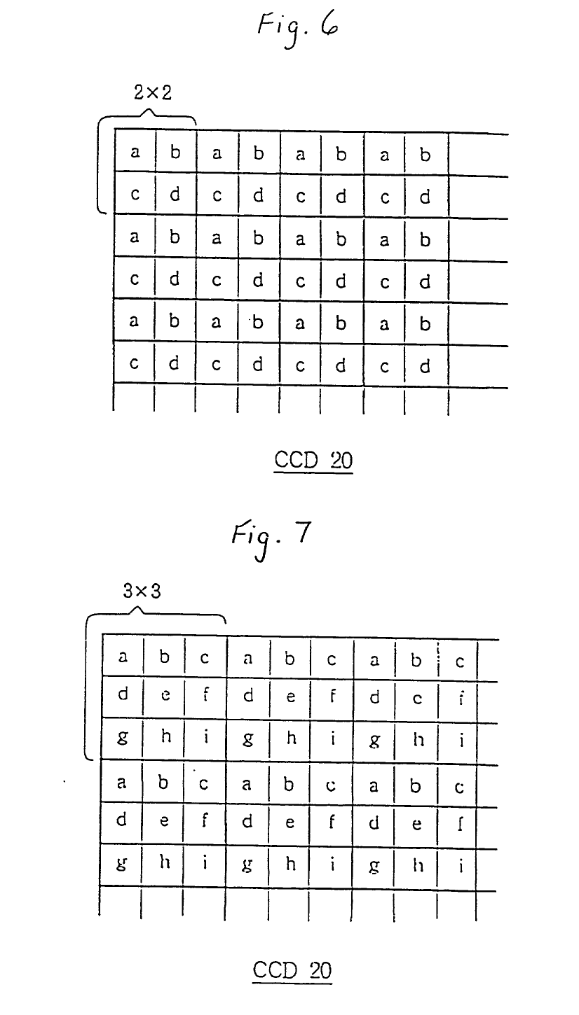

Namely, the CDS 31 divides the pixels of the CCD 20, arranged in matrix form, into regions defined by 3×3 pixels, as shown in FIG. 7. Further, from that one region (from one of those regions) (from those regions), it samples the image electrical signal of one pixel arranged in a prescribed position at a rate of 30 times per second, and thins out the eight remaining pixels.

For example, in the first round of sampling time (of one frame), the top left pixel “a” of each region is sampled, and the other pixels b through i are thinned out. In the second round of sampling time (of two frames), the pixel “b” arranged on the right side of the pixel “a” is sampled, and the other pixels a, and c through i, are thinned out. Then, in the third round onward of sampling times, pixel “c”, and then pixel “d”, etc., are respectively sampled, and the other pixels are thinned out. In short, sampling is performed of various pixels in each of the nine frames.

The image signals sampled by the CDS 31 (the image signals of 1/9 the pixels among all the pixels in the CCD 20) are provided to the A/D conversion circuit 32, are digitized there, and output to the DSP 33.

The DSP temporarily provides digitized image data to the buffer memory 37 and stores it. The compression/decompression memory control circuit 38 reads out the image data stored in the buffer memory 37, and compresses it according to the JPEG method. Doing thus, the data having undergone digitization and compression processing is provided to the memory card 24 via the data bus 42, and is recorded in the image recording area of the memory card 24 along with the photographic date and time header information.

It is also possible to project light on the objects by activating the strobe (light-emitting component) 4 according to need when photographing the objects.

Next, the actions when inputting two-dimensional information (pen input information) from the touch tablet 6A are explained. When the touch tablet 6A is pressed by the pen tip of the pen-type pointing device 6B, the data corresponding to the XY coordinates of the touched location is input into the CPU 34. The data corresponding to these XY coordinates is provided to the CPU 34, and the data, for example, the image data corresponding to points of a specified size, is written by the CPU 34 into the locations within the frame memory 37 corresponding to the XY coordinates mentioned above, and the points of the specified size are displayed.

Because the touch tablet 6A formed on the surface of the LCD 6 is composed of a transparent ma [symbol] , as explained above, the user can monitor the points displayed on the LCD 6 in the positions where the pen tip of the pen-type pointing device 6B has pressed the touch tablet 6A, and can feel just as if having performed pen input directly on the LCD 6. Also, when moving the pen-type pointing device 6B while contacting the touch tablet 6A, a line is displayed on the LCD 6 following the tracks of the movement of the pen-type pointing device 6B. Furthermore, when intermittently moving the pen-type pointing device 6B on the touch tablet 6A, a broken line is displayed on the LCD 6 following the movement of the pen-type pointing device 6B. In the above manner, the user can input using the touch tablet 6A (LCD 6) the desired line-drawing information such as characters and figures, and the like.

Also, when line-drawing information, such as characters, and the like, is input using the pen-type pointing device 6B while images are displayed on the LCD 6, this line-drawing information is composed in the buffer memory 37 along with the image information, and is displayed at the same time on the LCD 6.

It can be made such that the user can select the colors displayed on the LCD 6 from multiple colors such as black, white, red, blue, and the like, by operating a color selection switch, not shown.

When the execute (run) key 7B of the operating keys 7 is pressed after input of the line-drawing information to the touch tablet 6A using the pen-type pointing device 6B, the line-drawing information stored in the specified memory is provided to the memory card 24 via the CPU control bus 41 along with the input date and time header information, and is recorded in the line-drawing recording area of the memory card 24.

The line-drawing information recorded on the memory card 24 is information having undergone compression processing. Because the line-drawing information input into the touch tablet 6A includes a great deal of information of high spatial frequency, when performing compression processing by the JPEG method used for compression of the images mentioned above, the compression efficiency is poor and the amount of information does not become small. Also, because compression by the JPEG method is irreversible compression, it is not suitable for compression of line-drawing having a small amount of information. This is because gathering and spreading become prominent due to gaps of the information when decompressed and displayed on the LCD 6.

Thus, in the present preferred embodiment, the line-drawing information is compressed by the run-length method as used by facsimiles, and the like. The run-length method is a method of compressing line-drawing information by scanning the line-drawn screen in the horizontal direction, and coding the running lengths of the (points of) information of each color, being black, white, red, blue, and the like, and the running lengths of the non-information (the parts having no pen input).

By using this run-length method, it is possible to compress efficiently the line-drawing information, and also, it becomes possible to suppress the gaps of information even when having decompressed the compressed line-drawing information. When the amount of information of the line-drawing information is comparatively small, it also can be made so as not to compress it.

Also, as described above, when performing pen input while images are displayed on the LCD 6, the image data and the pen-input line-drawing information are composed in the buffer memory 37, and the composed image of the image and the line drawing is displayed on the LCD 6. Nevertheless, in the memory card 24, the image data is recorded in the image recording area, and the line-drawing information is recorded separately in the line-drawing information recording area. In this manner, because the two types of information are recorded respectively in different areas, the user can delete only one of the image and the line drawing from the composed image. Also, it is possible also to compress each type of image information by separate compression methods.

In the event that a plurality of information (photographic image, voice, line drawing) is input simultaneously, the various types of information are recorded individually in the prescribed region of the memory card 24; however, the identical date/time header information accompanies these various types of information.

For example, when photographic image information, voice information, and line drawing information, are input at the same time, each piece of information recorded in the prescribed region of the memory card 24 is provided respectively as simultaneously input date/time data header information. Further, the date/time data from any one of the input informations may be treated as data essentially related to any other of the input informations.

The information that has been simultaneously input is replayed simultaneously during replay.

Further, in the present embodiment, after the first type of information (for example, photographic image) has been recorded, the second information, that is different from the first information, (for example, line drawing) can be recorded in an added (attached) form to the first information. In this way, in the event that the second information is added as attached to the first information, the second information is input in the form in which the first information was replayed.

This case is explained below in detail.

For example, in the event that the preset voice information is replayed, the release switch 10 is pressed, and the process of photographing the subject is performed, the date/time header information initiated by the recording of the voice information accompanies the photographic image data recorded in the photographic image recording region of the memory card 24.

Further, for example, during replay of the voice information initiated by the recording of 10:05, Aug. 25, 1995, when one minute has elapsed from the start of replay (namely, when the replay data becomes data of 10:06, Aug. 25, 1995), the photographic process is performed, and the header information of 10:06, Aug. 25, 1995, can also accompany the photographic image data recorded in the photographic image recording region of the memory card 24 (moreover, the start time (10:05) may be defined as the header information, and either side may be recorded as the default (this selection is made by the user).

In the same way, in the event that the preset voice data is replayed, the line-drawing information is input, and, in conjunction with that line-drawing information, the voice information recorded date/time header information is recorded as identical header information in the line-drawing information recording region of the memory card 24.

In the case that the voice information and photographic image information, both input at the same time, are replayed, when the line-drawing information is input, in conjunction with that line-drawing information, the header information identical to the voice information (or the photographic image information) of the recorded date/time header information is recorded in the line-drawing information recording region of the memory card 24.

In the event that the simultaneously input voice information and line-drawing information are replayed, when the Photographic image information is input, in conjunction with the photographic image data, the voice information (or line-drawing information) of the recorded date/time header information is recorded as identical header information in the photographic image recording region of the memory card 24.

In the event that the pre-input photographic image is replayed, when the voice information is input, in conjunction with this voice data, the photographic image recorded date/time header information is recorded as identical header information in the voice information recording region of the memory card 24.

In the event that the pre-input photographic image is replayed, when the line-drawing information is input, in conjunction with this line-drawing information, the photographic image recorded date/time header information is recorded as identical header information in the line-drawing information recording region of the memory card 24.

In the event that the simultaneously input photographic image information and the line-drawing information are replayed, when the voice information is input, in conjunction with this voice data, the photographic image information (or the line-drawing information) recorded date/time header information is recorded as identical header information in the voice recording region of the memory card 24.

In the event that the pre-input line-drawing information is replayed, when the photographic image information is input, in conjunction with this photographic image data, the line-drawing information recorded date/time header information is recorded as identical header information in the photographic image recording region of the memory card 24.

In the event that the pre-input line-drawing information is replayed, when the voice information is input, in conjunction with this voice data, the line-drawing information recorded date/time header information is recorded as identical header information in the voice recording region of the memory card 24.

As described above, in the event that the prerecorded first information is replayed, when the second information is input, the first information recorded date/time becomes defined as the second information header information. In accordance with this, even if information is attached thereafter, the connection of the original (base) information and the attached information can be preserved.

Next, the case of voice recording at the time when the subject is photographed is explained.

First, the case in which the continuous shooting mode changeover switch 13 is changed over to the S mode (continuous shooting mode) is explained. First, when the sound recording switch 12 is pressed, the voice information input is performed, and in conjunction with the voice data, the recording initiation date/time header information is recorded in the voice information recording region of the memory card 24. Then, during the voice information input, when the release switch 10 is pressed (S mode), the subject is photographed in one frame, and this photographic image data is recorded in the memory card 24. The date/time header information accompanies this photographic image data at the time (photographic initiation time) that the release switch 10 is pressed.

On the other hand, first, when the release button 10 is pressed, the subject is photographed in one frame. At this time, the date/time of the time of photography is recorded as header information in the photographic image data recorded in the memory card 24. Furthermore, when the release button 10 is pressed continuously, the photographed image is displayed on the LCD 6; at this time, when the sound recording switch 12 is pressed, the sound recording information is input. At this time, the date/time of the time photographed accompanies the voice data recorded in the voice information recording region of the memory card 24, as header information.

Next, the case in which the continuous shooting mode changeover switch 13 is changed over to the L mode or the H mode (continuous shooting mode) is explained. First, when the release switch 10 is pressed, in the event that next, the sound recording switch 12 is pressed, and in the event that the release switch 10 and the sound recording switch 12 are pressed at the same time, the photographic information and the voice information are recorded as follows.

In the event that the continuous shooting mode changeover switch 13 is changed over to the L mode, photography is performed at 8 frames per second, and the respectively photographed date/time header information accompanies the photographic image data of each frame recorded in the photographic image recording region of the memory card 24. Accordingly, in the header of each frame, the date/time at 0.125 second intervals are recorded. Further, at this time, the voice information is recorded at 0.125 seconds each (however, it is continuously input), and for the voice data as well, recorded in the voice information recording region of the memory card 24, the date/time header information is recorded at 0.125 second intervals.

In the same way, in the event that the continuous shooting mode changeover switch 13 is changed over to the H mode, photography is performed at 30 frames per second, and the respectively photographed date/time header information accompanies in each frame of photographic image data recorded in the photographic image recording region of the memory card 24. Accordingly in the header of each frame, the date time is recorded at 1/30 second intervals. Further, at this time, the voice information is recorded at 1/30 seconds each (however, it is continuously input), and, even for the voice data recorded in the voice information recording region in the memory card 24, the header information of the date/time is recorded at 1/30 second intervals.

According to what has been described above, in the event that the photographic image or voice is edited after recording, when optional photographic images are deleted, this photographic image header information and voice information having the identical header information can also be deleted.

On the other hand, in the event that the continuous shooting mode changeover switch 13 has been changed over to the L mode or the H mode (in the event that it has been changed over to the continuous shooting mode), when the sound recording switch 12 is pressed first, and the release switch 10 is pressed after that, header information as described below is recorded in the information recorded in the memory card 24.

In other words, in this case, the voice data up until the release switch 10 is pressed is recorded as one file in the voice information recording region of the memory card 24. After that, in the case that the release switch 10 is pressed, the date/time header information corresponding to each photographic image frame is recorded in conjunction with the voice data.

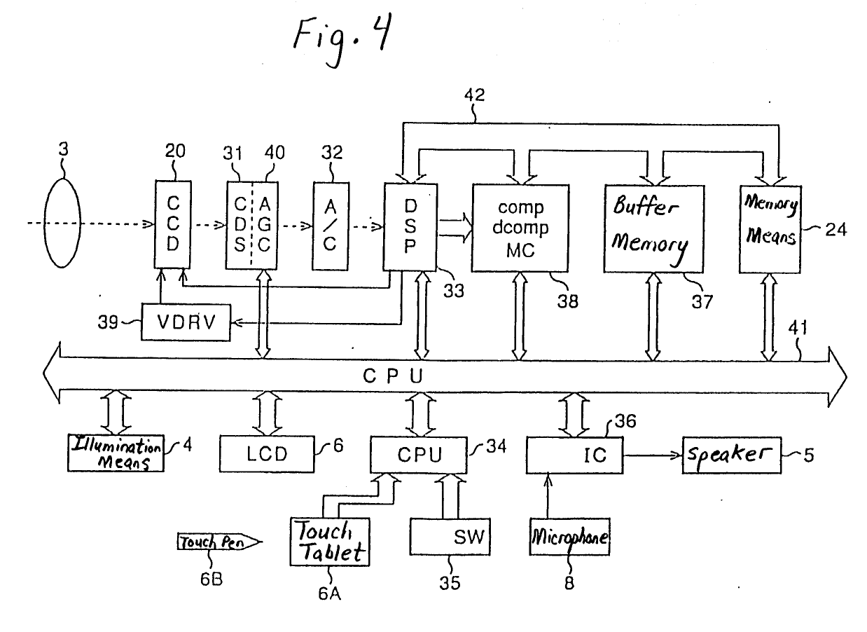

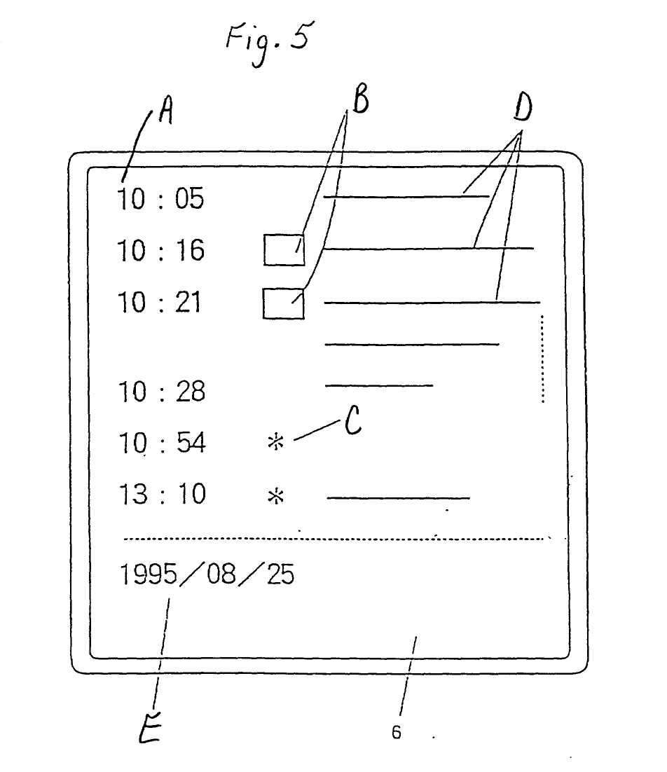

When having recorded the data recorded in at least one of the voice recording area, image recording area, and line-drawing information recording area of the memory card 24, a list display screen of the recorded information can be displayed to the LCD 6 as shown in FIG. 5. On the LCD 6 display screen shown in FIG. 5 is displayed at the lower end of the screen the date E, the time the information was recorded (the recording date) (in this case, Aug. 25, 1995), and the recording time A of the information recorded on that recording date is displayed on the leftmost side of the screen.

On the right side of the recording time are displayed thumbnail images B when image data is recorded. These thumbnail images are reduced images created by thinning out the bit-mapped data of each image data of the image data recorded on the memory card 24. Consequently, the information displayed by the thumbnail images B is information including the image information. That is, the information recorded (input) at “10:16” and “10:21” includes image information, and the information recorded at “10:05” “10:28,” “10:54,” and “13:10” does not include image data.

Also, the memo symbol “*” C displays that a memo is recorded as line-drawing information.

Furthermore, on the right side of the thumbnail image display area is displayed a voice information bar D. A bar (line) of a length corresponding to the length of the voice recording time is displayed. When voice information is not input, it is not displayed.

The user selects the information to reproduce by pressing with the pen tip of the pen-type pointing device 6B inside the rectangular area wherein the desired information is displayed on the LCD 6 shown in FIG. 5, and reproduces the selected information by pressing the execute (run) key 7B shown in FIG. 2 with the pen tip of the pen-type pointing device 6B. Thereby, the selected information is output.

For example, when the inside of the area of the band wherein “10:05” is displayed on the screen shown in FIG. 7 is pressed by the pen-type pointing device 6B, the CPU 34 instructs the voice IC 36 to read out the voice data corresponding to the selected voice recording time (10:05).

The voice IC, after having read out the voice data from the memory card 24 according to the instructions of the CPU 34 and applied decompression processing, outputs it from the speaker 5. When an earphone, not shown, is connected to the earphone jack 9, the voice is not output from the speaker 5, and is reproduced via the earphone.

When reproducing image data recorded on the memory card, the user selects that information by pressing on the desired thumbnail image with the pen tip of the pen-type pointing device 6B, and then instructs reproduction of the selected information by pressing the execute (run) key 7B.

The image data corresponding to the selected thumbnail is read out from the memory card 24, and is decompressed in the compression/decompression memory control circuit 38. The decompressed image data is provided to the buffer memory 37 via the data bus 42, and is stored as bit-mapped data. Next, control signals corresponding to the image data stored in the buffer memory 37 are provided to the LCD 6 by the CPU 34, and the corresponding image is displayed.

The image photographed in the S mode is displayed as a stationary (still) image in the LCD 6. This stationary image is the replay of all of the image signal pixels of the CCD 20.

The image photographed in the L mode is displayed continuously at a rate of 8 frames per second on the LCD 6. The number of pixels displayed in each frame is ¼ the number of all the pixels of the CCD 20.

The human eye, when sensitively receiving a stationary image of inferior resolution, thins out the stationary image pixels, and the user interprets an inferior quality. However, by raising the continuous shooting speed of the photographic time, i.e., photography of 8 frames per second in the L mode, the image is replayed at the speed of 8 frames per second, with the number of each frame image becoming ¼ of the number of pixels of the CCD 20. The human eye observes the image of 8 frames per second, with the result that is the human eye receives twice as much information in one second, as compared to the case with stationary images.

More particularly, when the number of pixels of one frame of the image photographed in S mode is defined as 1, the number of pixels of one frame of the image photographed in L mode is defined as ¼. In the event that the image (stationary image) photographed in S mode is displayed on the LCD 6, the amount of information received by the human eye in one second becomes defined as 1 (=(number of pixels: 1)×(number of frames: 1). On the other hand, in the event that the image photographed in the L mode is displayed on the LCD 6, the amount of information received by the human eye per second is 2 (=(number of pixels: ¼)×(number of frames: 8) (namely, to the human eye, twice the information of the stationary images is received). Accordingly, in the replay time even of ¼ the number of the pixels of one frame, the user can observe the replay image while perceiving a superior image quality to that obtained in S mode.

Furthermore, in the present embodiment, different pixels in each of the frames are sampled (different pixels are sampled respectively from each of the frames), and those sampled pixels are displayed on the LCD 6. As a result, the remaining image effect is generated in the human eye. Even if ¾ of the pixels per frame are thinned out, the user can observe the image photographed in the L mode that is displayed on the LCD 6, without concern about worsening (making inferior) the image quality.

Further, the image photographed in the H mode is displayed continuously at a rate of 30 frames per second in the LCD 6. At this time, [symbol] pixels displayed in each frame is 1/9 the number of all the pixels of the CCD 20. However, for the same reason as when in the L mode, the user can observe the image photographed in H mode, displayed on the LCD 6, without concern over making the image quality inferior.

In the present embodiment, when the subject is photographed in the L mode and the H mode, the CDS 31 thins out pixels of the CCD 20 to a level that does not cause concern over making the image quality inferior during replay. As a result, the load (burden) of the DSP can be reduced, and the DSP 33 can be operated at low speed and low electrical power. Further, due to this, it is possible to lower the cost of the apparatus and make it so it has a low consumption of electrical power.

At this time, when voice data is recorded (for example, when the recording times are “10:16” and “10:21”), it can also be made so as to output the voice information from the speaker 5 in the manner described above.

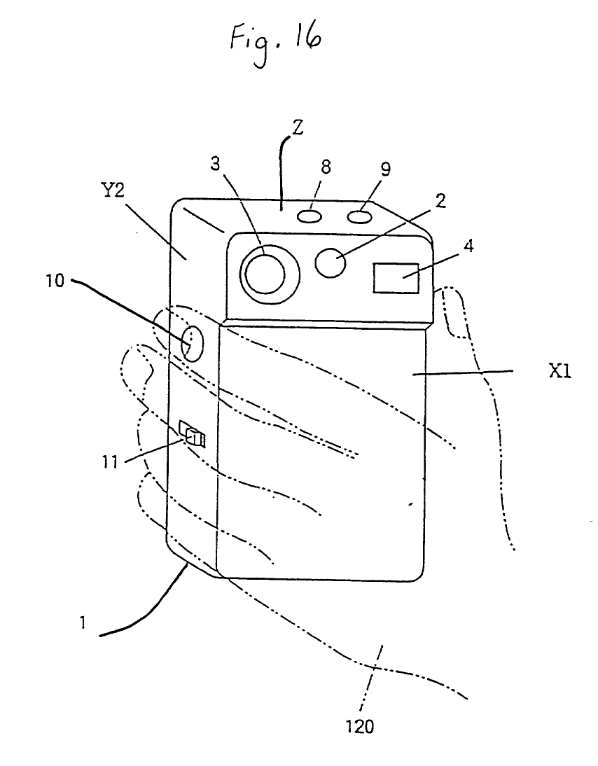

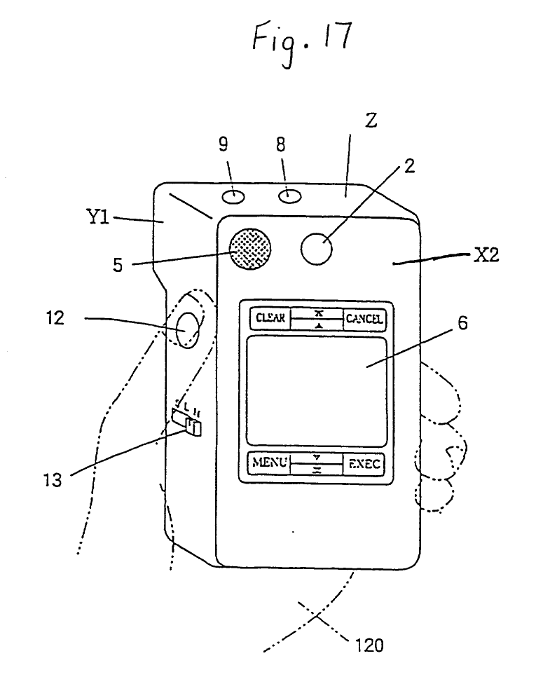

Next, the holding of the information input apparatus 1 of the present embodiment is explained with reference to FIGS. 16 and 17. Namely, in the information input apparatus 1 of the present embodiment, the finder 2, employed for photography of the subject, and a photographic lens 3 and light emitting component 4 are provided in the upper projection of the apparatus main body. Further, the microphone 8 for inputting voice is provided on the top plane (surface Z) of the apparatus main body.

Further, the release switch 10, operated when photographing the subject, and sound recording switch 12, operated when inputting voice, are provided respectively on surfaces Y1 and Y2, directly below the finder 2, the photographic lens 3, the light emitting component 4, and the microphone 8.

Furthermore, on the surface [symbol] the LCD 6 is positioned directly below the finder 2, in the apparatus interior, and, the batteries 21 and the condenser 22, shown in FIG. 3, are provided directly below the LCD 6.

Holding the pen-type pointing device in the right hand, when line-drawing information is input into the LCD 6 (touch tablet 6A), as shown in FIG. 16 and FIG. 17, the user holds the surface X1 (the surface opposing the surface X2 formed in the LCD 6) securely in the palm of the left hand 120.

In this electronic camera 1, a sufficient length is maintained directly below the finder 2, the photographic lens 3, and the light emitting component 4, for providing space for the batteries 21 and the condenser 22, and, by holding the apparatus in the left hand 120, each of the parts 2 through 4 are left uncovered. Further, in the present embodiment, the index finger of the left hand 120 of the user is positioned at the position where the release switch 10 provided on the surface Y2 is formed, and the thumb of the left hand 120 is positioned in the position where the sound recording switch 12 provided on the surface Y1 is formed. Accordingly, when line-drawing information is being input to the touch tablet 6A, even if a sudden photo opportunity presents itself, the subject can be photographed by pressing the release switch 10 with the index finger of the left hand, and voice can be input by pressing the sound recording switch 12 with the thumb.

Further, the release switch 10 is provided on the side surface (surface Y2) which is on the user's right; as a result, the user can operate the release switch 10 with the right hand, in the same way as in an ordinary camera.

Moreover, in the information input apparatus 1 of the present embodiment, the user, when holding the information input apparatus 1, has no obstacles when using either the right or [symbol] the release switch 10 and the sound recording switch 12 are formed symmetrically on the right and left, formed at almost the same height.

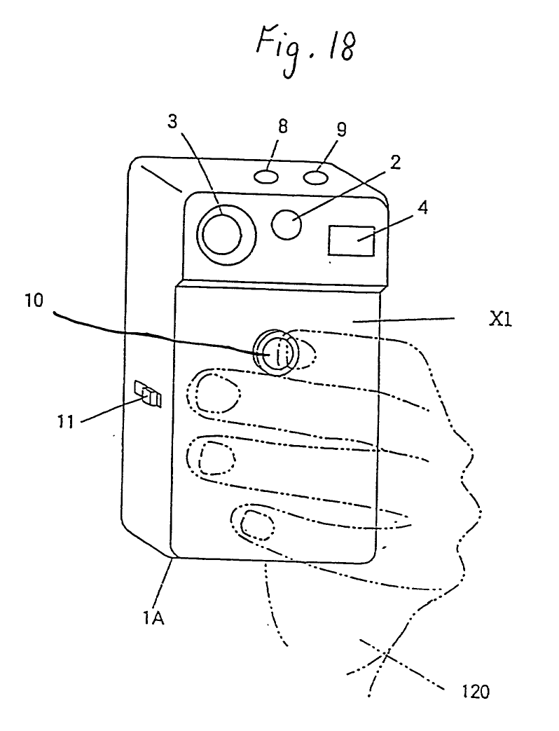

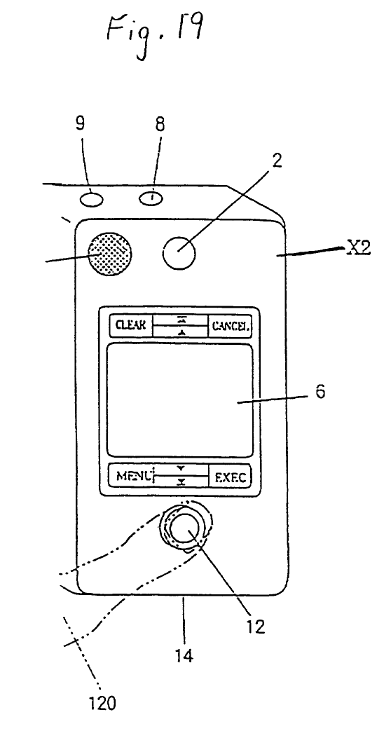

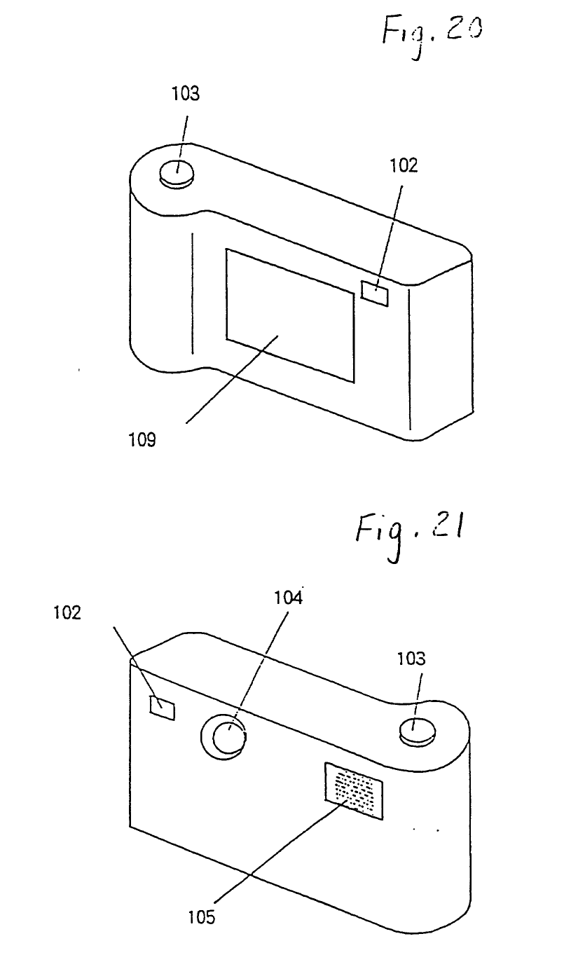

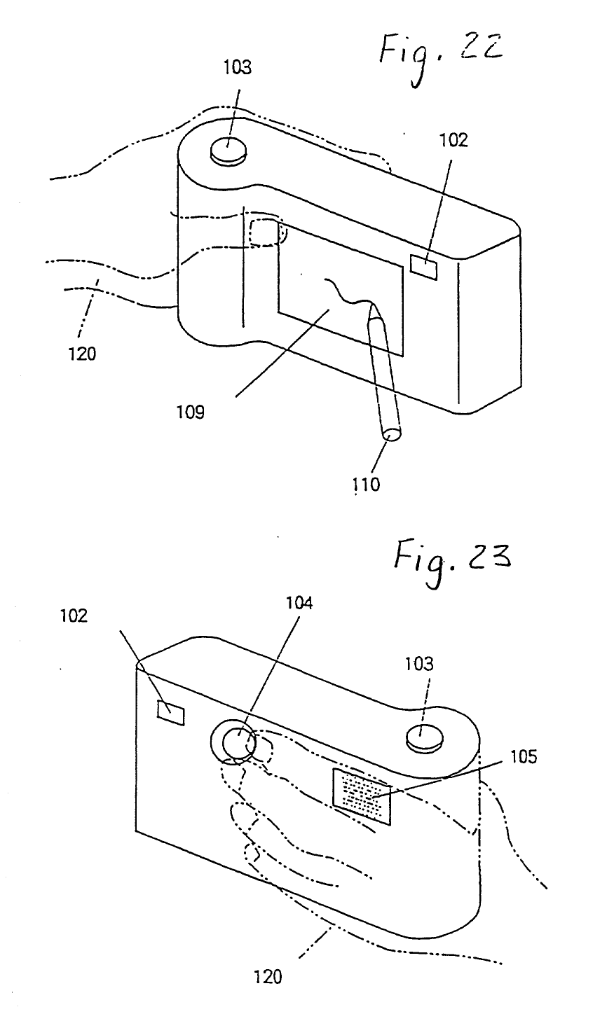

In an alternative embodiment, as shown in FIGS. 18 and 19, the release switch 10 and the sound recording switch 12 can also be positioned respectively on surfaces X1 and X2. In this case as well, switches 10 and 12 are positioned below the finder 2, photographic lens 3, and the light emitting component 4. With type of positioning as well, each of the parts 2 through 4 of this electronic camera 1A is not covered by the left hand 120 of the user, and the electronic camera 1A can be reliably held. The sound recording switch 12 can be operated by thumb, and the release switch 10 can be operated by index finger.

FIG. 8 shows the electronic camera 1 positioned in a shirt pocket. Thus, the electronic camera 1 is shaped so as to go into the shirt pocket, and furthermore, at that time, the photographic lens 3, finder 2, and light-emitting component 4 positioned along the upper projection of the electronic camera 1, protrude from the shirt pocket. In this manner, the user can photograph images of the specified objects while the electronic camera 1 is in the shirt pocket. Also, voice recording is possible.

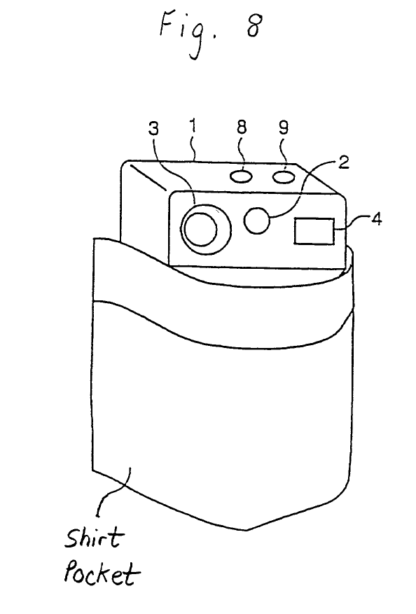

Next, the shape of the electronic camera 1 that can be used while inserted into a shirt pocket is explained as shown in FIG. 9.

As shown in FIG. 9, the height of the housing of the electronic camera 1 is L1, the width of the housing is L2, and the depth of the housing is L3. The distance from the lower edge of the photographic lens 3 of the electronic camera 1 to the bottom surface of the camera is L4.

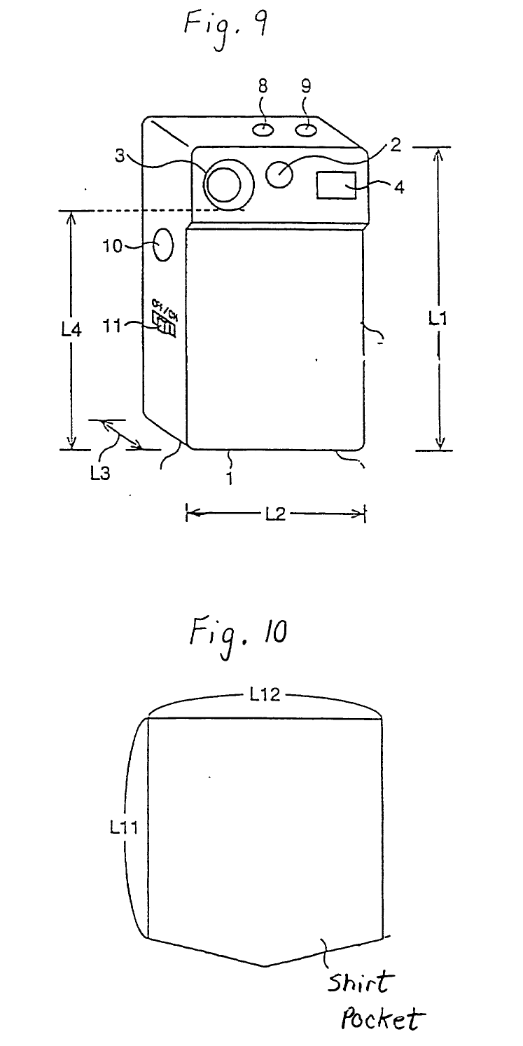

As shown in FIG. 10, the height of a typical shirt pocket is L11, and the width is L12. In order to make the electronic camera 1 fit into the shirt pocket, the outer perimeter of the electronic camera 1 at the portion of the camera below the upper projection must be less than or equal to two times the width L12 of the shirt pocket.

The electronic camera 1 shown in FIGS. 9, 13 and 14 is drawn with sharp corners, but in practice, the corners may be rounded, and the shape of the cross section of the camera may assume a variety of configurations. As shown in FIG. 15, a cross sectional configuration for an embodiment of the electronic camera with a contoured outer perimeter requires a shirt pocket wherein 2×L12≧L.

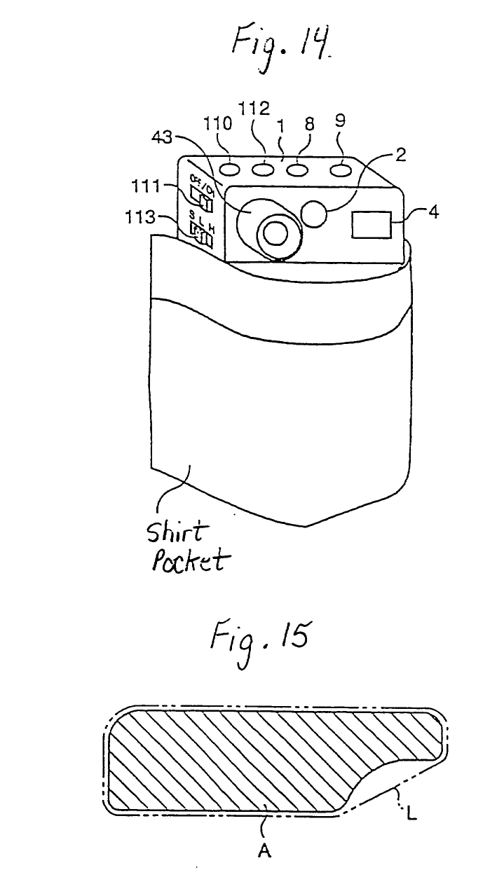

As an example, if the width of the shirt pocket shown in FIG. 14 is 9 cm, then the perimeter of the electronic camera at the portion of the camera below the upper projection must be no more than 18 cm. For example, if the width L2 of the camera 1 is 7 cm and the depth L3 is 2 cm, then the total length of the outer perimeter of the camera at the portion of the camera below the upper projection is exactly 18 cm, and the electronic camera 1 will fit, tightly, into the pocket.

Next, in order for the photographic lens 3, the finder 2, and the light-emitting component 4 placed on the upper projection of the electronic camera 1 to protrude from the pocket when the electronic camera is placed into the shirt pocket, the length L4 from the lower edge of the photographic lens 3 to the bottom surface of the electronic camera 1 must be at equal to or greater than height L11 of the shirt pocket.

If the height of the shirt pocket shown in FIG. 14, for example, is 11 cm, then the height of the electronic camera from the bottom edge of photographic lens 3 to the bottom surface of the camera must be at least 11 cm. In practice, because the shirt pocket bulges when having inserted the electronic camera 1 into the pocket, the length L4 from the lower edge of the photographic lens 3 to the bottom surface of the electronic camera 1 can be made even slightly shorter than 11 cm. Consequently, height L1 of the electronic camera 1 can be made even slightly less than the diameter of lens 3 plus the length L4 from the lower edge of the photographic lens to the bottom surface of the camera.

By selecting the outer dimensions according to the above criteria, the electronic camera 1 can be made in a shape that can be inserted into a shirt pocket, and it becomes possible to photograph the specified objects while the electronic camera 1 is inserted into the shirt pocket. Also, in this manner, because the electronic camera 1 is oriented with the direction of the height of the camera being vertical and the direction of the width of the camera and the upper projection of the-camera being horizontal, the photoelectric device CCD 20 is positioned at the same vertical height as lens 3, thus making it possible to match the vertical direction of the images of the photographed objects with the vertical direction of the photographed objects themselves.

Next are explained the positional relationships among the photographic lens 3, the finder 2, and the light-emitting component 4 placed in the upper projection of the electronic camera 1. As shown in FIG. 1, the photographic lens 3, finder 2, and light-emitting component 4 are placed in this order from the left when observed from the front X1 of the electronic camera 1.

Consequently, the photographic lens 3 is placed at the left side on the front X1 of the electronic camera 1, the finder is placed roughly in the center, and the light-emitting component 4 is placed at the right side.

Ordinarily, because the shirt pocket is provided on the right side when facing [symbol] and the photographic lens 3 of the electronic camera 1 is placed at the left side of the front X1 of the camera, the photographic lens 3 is positioned at the left side of the pocket as shown in FIGS. 8, 13 and 14 when the camera is inserted in the pocket. Consequently, even when wearing clothing such as a suit jacket over the shirt, for example, blocking of the photographic lens 3 by the lapel of the suit jacket is prevented. Also, even when the photographic lens 3 is blocked by the lapel of the suit jacket, it is possible to aim the photographic lens 3 at the object, and to photograph the object after opening the lapel slightly.

Also, if the width of the electronic camera 1, for example, is made 8 cm or less, corresponding to the distance between the human eyes, because each distance from the finder 2 of the electronic camera 1 to the left and right ends of the case 100 of the electronic camera is less than or equal to 8 cm, the eye not looking through the finder 2 can observe the object when one eye is looking through finder 2.

Also, as shown in FIG. 1, when the finder 2 has been placed in roughly the middle position relative to the width of front side X1 of the electronic camera 1, because each distance from the middle of the finder 2 to the left and right sides of the electronic camera 1 is approximately 4 cm, or less, the eye not looking through the finder 2 can observe the object at a sufficient angle of vision, even taking into account the depth L3 of the minimum side of the electronic camera 1.

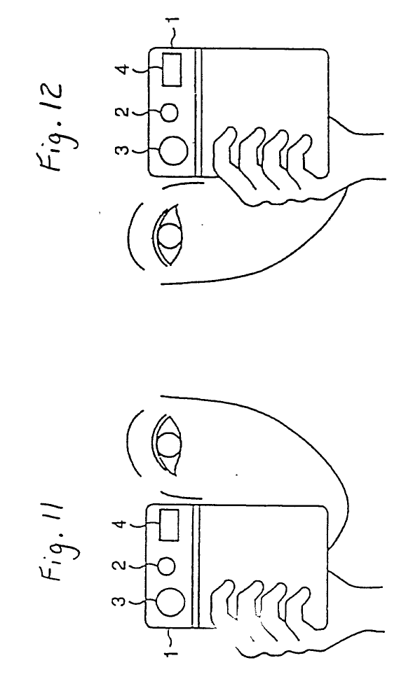

Thus, regardless as to whether the eye looking through the finder 2 is the right eye as shown in FIG. 11 or the left eye as shown in FIG. 12, because the light from the object enters the other eye not looking through the finder 2 without being blocked by the case 100 of the electronic camera 1, the user can observe the object with the left and right eyes.

Also, because the photographic lens 3 and the light-emitting component 4 are placed on the left and right of the finder 2, the distance between the photographic lens 3 and the light-emitting component 4 is maximized to the extent possible, thus the red-eye phenomenon can be controlled, and it is possible to inhibit the negative effects on the imaging element of the CCD 20 provided at the rear of the photographic lens 3 due to the electromagnetic radiation (noise) generated when the light-emitting component 4 has emitted light.

Furthermore, by placing the finder 2 and the photographic lens 3 adjacent to each other, the parallax, that is, the difference between the range visible by the finder (finder vision) and the image range resolved on the CCD 20 via the photographic lens 3 (lens vision), can be reduced.

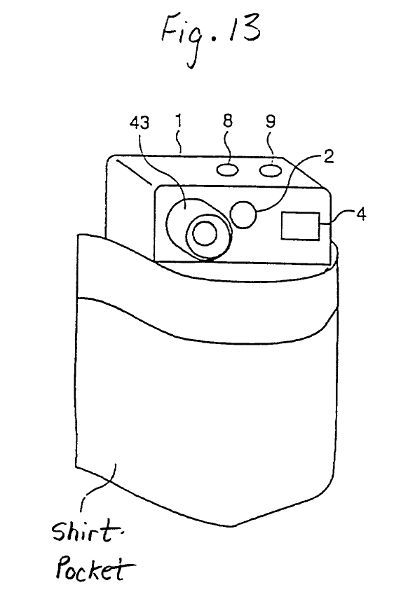

FIG. 13 shows the an embodiment of the electronic camera 1 with a telescoping photographic lens 43. In this embodiment, the photographic lens 43 of the electronic camera 1 telescopes in the forward direction (the direction of the object). The photographic lens 43 can be fixed in such a protruded state, or it can be made so as to protrude forward only when photographing objects. For example, it can be made so that the photographic lens 43 protrudes forward when the power is turned on by the power switch 11 being operated.

By making the photographic lens 43 protrude forward in this manner, it is possible to prevent the photographic lens 43 from being hidden by the shirt pocket. Also, it is possible to prevent the photographic lens 43 from being hidden by the lapel of the suit jacket, for example, when wearing a suit jacket over the shirt.

As explained above while referring to FIG. 3, the relatively heavy-weight dry cells [symbol] are placed at the lower part of the electronic camera 1. Because the electronic camera 1 mentioned above is used in a state whereby the placement of the photographic lens 3 is in the upper projection, the camera remains balanced and stable because the lower half where the dry cells 21 are placed is heavier than the upper half. Thus, it is possible to inhibit trembling of the camera during photography.

Also, as explained above while referring to FIG. 1, because the release switch 10, power switch 11, voice recording switch 12, and continuous mode switch 13 are placed on the sides of the electronic camera 1, when performing photography in the condition of having inserted the electronic camera 1 into the shirt pocket, it is possible to prevent erroneous operation of the electronic camera 1 due to the switches being erroneously operated, for example, by bumping into other people in a crowd.

In the embodiment of the electronic camera 1 as shown in FIG. 14, a release switch 110, power switch 111, voice recording switch 112, and continuous mode switch 113, respectively have the same functions as the release switch 10, power switch 11, voice recording switch 12, and continuous mode switch 13 as shown in FIG. 1 and FIG. 2. The placement of the above-mentioned switches in positions vertically higher on the camera relative to the bottom surface of the camera than the height L11 of the shirt pocket, allows these operating components to extend from the pocket even when the electronic camera 1 is inside the shirt pocket, and the usability can be increased.

In the preferred embodiments mentioned above, the finder 2 was made an optical item, but it is also possible to use a liquid crystal finder.

Also, in the preferred embodiments mentioned above, the photographic lens, finder, and light-emitting component were arranged in this order from the left when viewed from the front of the electronic camera, but it is also possible to arrange them from the right.

Also, in the preferred embodiments mentioned above, there was only one microphone, but it can be made to have two microphones, such that the voice information can be recorded in stereo.

Also, in the preferred embodiments mentioned above, the various types of information were input using a pen-type pointing device, but it can be made so as to input using a finger.

Furthermore, in the preferred embodiments mentioned above, the display screen displayed on the LCD 6 is one example, but it is not limited to this, and it can be made to use screens of various layouts. Similarly, the types and layout of the operating keys were one example, and it is not limited to these.

What is claimed is:

1. An information input apparatus, comprising:
a housing, said housing having outer dimensions including a height, a width and a depth, with the height being the maximum dimension, the width being the intermediate dimension and the depth being the minimum dimension, a front surface of said housing having an upper portion across the width of said housing projecting forward from the rest of the front surface to form an upper projection;
a photographic lens being mounted in said upper portion for receiving an image from an object;
a photoelectric device also being mounted in said upper portion for converting said image into first electrical signals;
said photographic lens and said photoelectric device each being positioned in said upper portion at a first vertical height from a bottom surface of said housing; and
an electronic memory device being housed within said housing at a second vertical height from the bottom surface of said housing, with said second vertical height being less than said first vertical height, said electronic memory device receiving and storing said first electrical signals.

2. The information input apparatus according to claim 1, wherein:
said first vertical height is greater than a standard height of a shirt pocket; and
a perimeter of said housing below said upper projection is less than two times a width of a standard shirt pocket.

3. The information input apparatus according to claim 2, wherein:
said first vertical height is 12 centimeters and said perimeter is 18 centimeters.

4. The information input apparatus according to claim 1, further including:
a power source that supplies power to said photoelectric device and said electronic memory device, said power source being mounted within said housing.

5. The information input apparatus according to claim 4, wherein:
said power source is positioned at a height relative to the bottom surface of said [symbol] that is less than said first vertical height.

6. The information input apparatus according to claim 4, further including:
an illumination device positioned within said upper portion and being connected to said power source.

7. The information input apparatus according to claim 6, further including:
a view finder, said view finder being positioned within said upper projection at approximately said first vertical height from the bottom surface of the housing, with said photographic lens being positioned at one end of said upper projection, said illumination device being positioned at an opposite end of said upper projection, and said view finder being intermediate said photographic lens and said illumination device.

8. The information input apparatus according to claim 7, further including:
a microphone for converting audible input into second electrical signals, said microphone being connected to said electronic memory device.

9. The information input apparatus according to claim 8, wherein:
said electronic memory device records said first and second electrical signals and associates identifying data with said recorded signals.

10. The information input apparatus according to claim 9, further including:
a display device that displays said images.

11. The information input apparatus according to claim 10, wherein:
a portion of said display device includes a touch tablet for receiving two-dimensional input data to be recorded by said electronic memory.

12. An information input apparatus, comprising:
a housing, said housing having a front surface, with an upper portion of said front surface across a width of said housing projecting forward from the rest of said front surface to form an upper projection, a back surface, a bottom surface and two side surfaces;
a photographic device being positioned within said upper projection and being operable to receive images from objects;
a first operating mechanism for operating said photographic device being positioned vertically below said photographic device; and
a touch-sensitive device for receiving two-dimensional positional data, said touch-sensitive device being located vertically below said photographic device.

13. The information input apparatus according to claim 12, further including:
an auditory sensor, said auditory sensor being operable to receive audible signals and convert said signals into electrical signals;
a second operating mechanism for operating said auditory sensor being positioned vertically below said photographic device and said auditory sensor.

14. The information input apparatus according to claim 13, wherein:
said touch-sensitive device is located on said back surface, said first operating mechanism is located on a first one of said side surfaces adjacent said back surface, and said second operating mechanism is located on a second opposing side surface.

15. An information input apparatus, comprising:
a housing, said housing having outer dimensions including a height, a width and a depth, with the height being the maximum dimension, the width being the intermediate dimension and the depth being the minimum dimension, a front surface of said housing having an upper portion across the width of said housing projecting forward from the rest of the front surface to form an upper projection;
an imaging means for receiving an image from an object and converting said image into first electrical signals, said imaging means being positioned in said upper projection at a first vertical height from a bottom surface of said housing; and
a memory means for recording said first electrical signals, said memory means being positioned within said housing at a second vertical height from the bottom surface of said housing, with said second vertical height being less than said first vertical height.

16. The information input apparatus according to claim 15, further including:
power supply means for supplying electrical power to said imaging means and said memory means;
illumination means for projecting illumination on said object;
monitoring means for optically monitoring said object; and
said imaging means, said monitoring means and said illumination means being lined up across said upper projection with said imaging means being at one end of said upper projection, said illumination means being at an opposite end of said upper projection, and said monitoring means being between said imaging means and said illumination means.

17. The information input apparatus according to claim 16, further including:
a display means for displaying said image; and
a voice input means for inputting selected voice information and converting said voice information into second electrical signals.

18. The information input apparatus according to claim 17, wherein:
said memory means records said first and second electrical signals with identifying information attached to said recorded signals.
